(19) United States
(12) Patent Application Publication
(10) Pub. No.: US 2004/0059446 A1
(43) Pub. Date: Mar. 25, 2004

(54) Mechanism and method for audio system synchronization

(76) Inventors: Mark L. Goldberg, Peoria, AZ (US); Eric K. Becker, Peoria, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/251,233

(22) Filed: Sep. 19, 2002

(51) Int. Cl. H04R 29/00; H04B 3/00; G06F 17/00

(52) U.S. Cl. 700/94; 381/58; 381/77

(57) ABSTRACT

A synchronization mechanism and method for synchronizing remote audio devices that are coupled together with a bus is provided. The synchronization mechanism compares a signal on the bus with a clock signal on the audio device and adjusts the clock in response to the comparison. This allows the synchronization mechanism to accurately synchronize remote audio devices without requiring high precision clocks or other complicated solutions. The synchronization mechanism and method are particularly applicable to synchronizing remote audio devices in a distributed audio system that digitally sample and broadcast for communication purposes. In this application, the synchronization mechanism improves audio quality by synchronizing the sampling and outputting of each audio device on the bus. This improves audio quality by reducing the distortion that occurs as a result of varying sample times.

### BACKGROUND OF THE INVENTION

1. Technical Field

This invention generally relates to electronic systems, and more specifically relates to distributed audio systems.

2. Background Art

Modern life is becoming more dependent upon electronic systems. Electronics devices have evolved into extremely sophisticated devices, and may be found in many different applications. As electronics become more integrated into daily life, their ability to communicate and work together becomes a greater and greater necessity.

The ability for electronic devices to work together is particularly problematic where the devices are remote from one another. In many applications, remote devices must be well integrated together to function properly. For example, in some audio systems, remote devices must be synchronized to properly function together. Without an effective means for synchronization of these audio devices, the separate audio devices cannot effectively function together.

Specifically, it is often desirable that remote audio devices by synchronized such that outputs and inputs at the remote audio devices occur together. This improves the sound quality by limiting interference between sounds generated by remote devices.

Unfortunately, in the past it has been difficult to provide the needed synchronization between remote audio devices. For example, in some cases the devices are remote enough that sharing a high speed clock signal between devices is impractical or otherwise undesirable.

Thus, what is needed is an improved method for synchronizing remote audio devices.

### BRIEF SUMMARY OF THE INVENTION

The present invention provides a synchronization mechanism and method for synchronizing remote audio devices that are coupled together with a bus. The synchronization mechanism compares a signal on the bus with a clock signal on the audio device and adjusts the clock in response to the comparison. This allows the synchronization mechanism to accurately synchronize remote audio devices without requiring high precision clocks or other complicated solutions. The synchronization mechanism and method are particularly applicable to synchronizing remote audio devices in a distributed audio system that digitally sample and broadcast for communication purposes. In this application, the synchronization mechanism improves audio quality by synchronizing the sampling and outputting of each audio device on the bus. This improves audio quality by reducing the distortion that occurs as a result of varying sample times.

The foregoing and other objects, features and advantages of the invention will be apparent from the following more particular description of a preferred embodiment of the invention, as illustrated in the accompanying drawings.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of a distributed audio system;

FIG. 2 is a schematic view of audio device with a synchronization mechanism;

FIG. 3 is a flow diagram of a method for synchronization;

FIG. 4 is a table illustrating a clock adjustment scheme; and

FIG. 5 is a table illustrating a scheme to determine when to make clock adjustments.

### DETAILED DESCRIPTION OF THE DRAWINGS

The present invention provides a synchronization mechanism and method for synchronizing remote audio devices that are coupled together with a bus. The synchronization mechanism compares a signal on the bus with a clock signal on the audio device and adjusts the clock in response to the comparison. This allows the synchronization mechanism to accurately synchronize remote audio devices without requiring high precision clocks or other complicated solutions.

The synchronization mechanism and method are particularly applicable to synchronizing remote audio devices in a distributed audio system that digitally sample and broadcast for communication purposes. In this application, the synchronization mechanism improves audio quality by synchronizing the sampling and outputting of each audio device on the bus. This improves audio quality by reducing the distortion that occurs as a result of varying sample times.

For example, the synchronization mechanism can be used in a distributed audio system for aircraft. In aircraft audio systems, several audio panels are located throughout the aircraft to facilitate communication between crew members and/or ground stations. In these applications, each audio panel typically includes a microphone input and a speaker output. Each audio panel is connected to a bus. Thus, audio information can be received at each microphone unit and put on the bus for distribution to other audio panels, where it is outputted by the speakers on the audio panels. This distributed audio system thus allows crew members at different locations throughout the plane to effectively communicate to each other.

In aircraft, the audio quality provided by the distributed audio system is of paramount importance. Without synchronization of the sampling and outputting times, the audio quality of the distributed audio system can be severely limited. The present invention provides a synchronization mechanism and method that can synchronize the operations of remote audio panels in an aircraft distributed audio system. The synchronization mechanism is used to synchronize the sampling and outputting that occurs at each audio panel. Additionally, the synchronization mechanism can be used to achieve proper time multiplexing of data transfer on the bus. The synchronization of sampling and data transfer leads to improved audio quality in the system, allowing the crew of the bus to easily and effectively communicate.

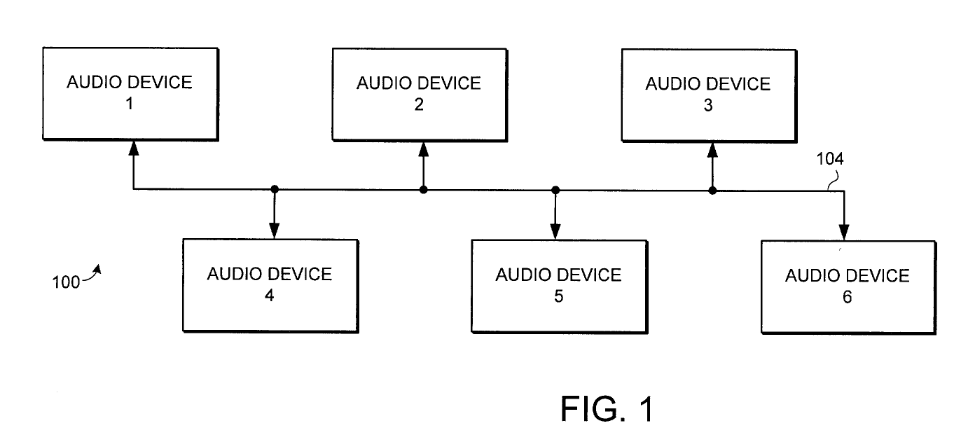

Turning now to FIG. 1, an exemplary distributed audio system 100 is illustrated schematically. The distributed audio system 100 includes audio devices 1-6 coupled together with bus 104. The distributed audio system 100 facilitates communication between people at remote locations, such as between different crew members of an aircraft. Audio communication is received at each audio device, and is transmitted across the bus 104 to the other audio devices where it is outputted. As will be explained in greater detail, the bus 104 is preferably a digital bus that uses multiplexing to allow communication from each audio device to every other audio device in the system 100 on a single bus.

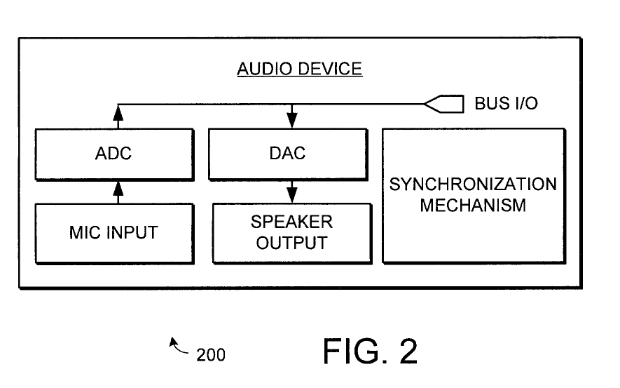

Turning now to FIG. 2, a more detailed schematic view of an exemplary audio device 200 is illustrated. The audio device 200 includes a bus I/O, a microphone input, a speaker output, an analog-to-digital converter (ADC), a digital-to-analog converter (DAC) and a synchronization mechanism. The microphone input receives audio communication from a user and sends it to the ADC, where it is converted to digital and put on the bus I/O. The DAC receives audio signals from bus I/O and passes the converted signals to the speaker where they are outputted back the user. The microphone input can be any suitable type of audio input that converts sound waves into a suitable electrical signals, including headset microphones commonly used in aircraft, telephonic devices, and other audio inputs. The speaker output can be any suitable audio output that converts electrical signals to audible sound, including loudspeakers, headphones, intercom systems, telephonic devices and other such devices.

The ADC and DAC can be any suitable type of converter. For example, they can comprise linear converters that convert 16 bit audio to a 16 bits per sample signal. These samples can then be converted to 8 bits per sample so two samples can be transmitted at a time at the slower rate.

Likewise, the bus I/O can be any suitable type of bus interface. In one example, the bus is a digital time multiplexed bus. In this type of bus, each audio device transmits in its own specified time slot. In such the bus the bus I/O could comprise a CODEC that encodes data to be put on the bus and decodes data from the bus, using any suitable encoding scheme. The bus I/O thus receives audio samples taken by the microphone input and converted by the ADC and encodes those samples into a format suitable for digital bus transmission. The bus I/O then puts those samples on the bus at a time slot specified for the audio device. Likewise, the bus I/O receives signals from the time slots associated with other audio devices. These signals can be decoded, filtered and summed, and the resulting output passed to the DAC. The DAC converts the resulting output and sends it to the speaker for outputting to the user.

The synchronization mechanism synchronizes the sample time of the microphone input with the sampling of microphones on other audio devices. Additionally, the synchronization mechanism can synchronize the output of the speaker with the outputs of other audio devices. Finally, the synchronization mechanism can be used to time the placement of data on the bus I/O by each audio device to achieve proper time multiplexing of data transfer on the bus.

The synchronization mechanism synchronizes the audio devices by comparing the time of arrival of some specified portion of the bus signal to a clock in the audio device. If the relationship between the time of arrival and the clock is off, the synchronization mechanism adjusts the clock rate to correct the timing. Small adjustments in the clock rate are used to move the clock in the proper phase relationship with the bus signal. These comparisons are preferably made at regular intervals, such as at each arrival of a packet on the bus. By continuously comparing the clock to the time of arrival of the specified portion of the bus signal, and then adjusting the clock in response to the comparison, the clock can be put in and kept at the proper phase relationship with the bus signal. With such a synchronization mechanism residing and operating on each audio device, the clocks on each audio device can be synchronized with the bus and thus to each other. This allows the all the audio devices on the distributed audio system to be synchronized such that each audio device samples from the microphone input and outputs to the speaker output at the same time.

The synchronization mechanism can selectively adjust the clock rate in any suitable manner or with any suitable procedure. One method for selectively adjusting the clock rate is to selectively add or subtract clock cycles to the source clock used to generate the timing clock. In this the discussion the term “timing clock” will be used to distinguish the clock that is to be adjusted for synchronization. The timing clock will generally be a clock that directly or indirectly controls the timing of sampling of audio signals from the microphone input and the outputting of audio signals at the speaker output.

In systems that use a variety of clocks, it is common for a high speed clock to serve as the basis for other clocks in the system. For example, the internal audio device can include an 80 MHz source clock that serves as the source clock for other clocks in the system. These other clocks would be generated by dividing down the 80 MHz clock to a lower clock speed. For example, the 80 MHz clock can be divided down by ten to generate an 8 MHz timing clock. The 8 MHz timing clock can be further divided down to provide other clocks, such as dividing by two to provide a 4 MHz bit clock that directly controls sampling. Of course, this is just one example of the type of clock arrangement that the synchronization mechanism applies to.

In such a system, one way to adjust the clock rate of the timing clock is to selectively add or subtract clock cycles to the source clock used to generate the clock. For example, depending of the difference between the timing clock and the arrival of the bus signal, the timing clock can be adjusted by adding (or subtracting) 0, 1, 2, 3, or 4 source clock signals to the master clock. In the example using the 80 MHz source clock and an 8 MHz timing clock, the timing clock can be adjusted by adding ±1, ±2, ±3, or ±4 source clock signals in between timing clock cycles. This creates a small adjustment in the rate of the 8 MHz timing clock, which in turn adjusts the 4 MHz bit clock. Thus, by selectively choosing the amount of adjustment made to the timing clock, the timing clock and the bit clock can be moved into a proper phase relationship with the bus signal. As an example, the 80 MHz to 8 MHz divider normally counts 10 transitions between switches of the output state. This causes the 80 MHz input clock to result in an 8 MHz output. The frequency of the output can be adjusted by instead counting 9 or 11 transitions between switches between 1 and 4 times during each 128 microsecond bus cycle.

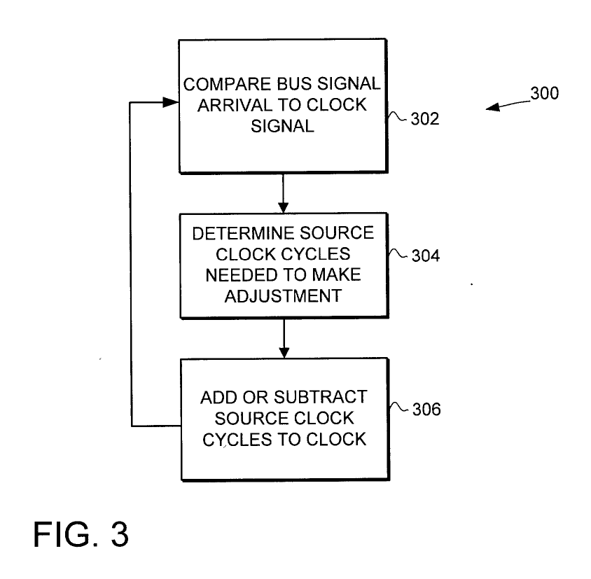

Turning now to FIG. 3, a method 300 for synchronizing audio devices is illustrated. The first step 302 is to compare the bus signal arrival to the clock signal. Typically, this can be done by comparing a known point on the bus signal, such as a selected time slot, with a selected clock edge. The difference amount from a desired clock phase and the current clock phase can be determined my measuring when a selected point on the bus signal arrives and comparing it the phase of the clock, and comparing the difference to the desired time difference. Thus, it can be determined if the timing clock signal has the proper phase relationship with the bus signal, and the amount it is off, if any. It should be noted that the timing clock does not need to be compared directly, and that instead a derivative clock, such as the exemplary 4 MHz bit clock can be compared, indirectly giving information on the timing of the timing clock.

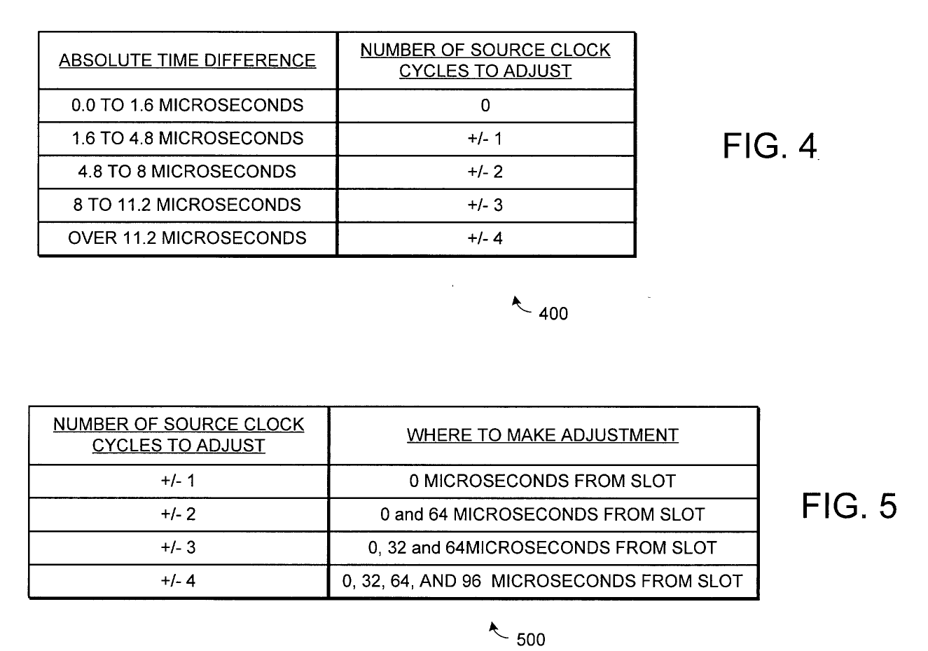

The next step 304 is to determine the number of source clock cycles to needed to make the adjustment. Generally, the greater the phase error, the greater the clock adjustment that is needed. Turning now to FIG. 4, a table 400 illustrating an adjustment scheme where the source clock is an 80 MHz clock and the timing clock is an 8 MHz clock. Table 400 illustrates a set of clock adjustments that can be used in the synchronization method. For example, when the absolute time difference between a clock event and a selected portion of the bus signal is 0.0 to 1.6 microseconds, the clock is not adjusted. When the difference is between 1.6 and 4.8 microseconds, the 8 MHz timing clock is adjusted by 180 MHz clock cycle. Thus, one additional 80 Mhz clock cycle is added to or subtracting from the 8 MHz timing clock cycle, thus slightly adjust the rate of the 8 MHz clock signal. If the audio device is early compared to the bus signal, clock cycles are added to make it later the next time. If the audio device is late, clock cycles are subtracted to make it earlier the next time. FIG. 4 thus gives one example of how the amount of clock adjustment needed can be determined based upon the absolute time difference determined.

Retuning to method 300, the next step 306 is to add or subtract source clock cycles to the timing clock. The number of cycles added or subtracted would be that determined in step 304. These cycles are added or subtracted by the clock divider.

Preferably, when multiple clock cycle adjustments are made they are spread out over the whole clock cycle. This allows the system to only have to deal with small changes, made relatively often, rather than large changes that could be more disruptive to the system. Turning now to FIG. 5, a table 500 illustrates an example of how multiple clock cycle adjustments can be spread out over the clock cycle. If only one 80 MHz clock cycle is to be added or subtracted from the 8 MHz clock, the change is done at the specified bus signal slot. If two 80 MHz clock cycles are to be added or subtracted, then one is done at the slot, and the other 64 microseconds from the slot. This spreads the resulting change throughout the 8 MHz timing clock cycle.

It should be again noted that the values given in FIGS. 4 and 5 are just an example of the type of determinations that can be made in adjusting the cycle of the clock. For systems with different clock speeds, the time difference and amount of cycles used would generally change.

The present invention thus provides a synchronization mechanism and method for synchronizing remote audio devices that are coupled together with a bus. The synchronization mechanism compares a signal on the bus with a clock signal on the audio device and adjusts the clock in response to the comparison. This allows the synchronization mechanism to accurately synchronize remote audio devices without requiring high precision clocks or other complicated solutions.

The synchronization mechanism and method are particularly applicable to synchronizing remote audio devices in a distributed audio system that digitally sample and broadcast for communication purposes. In this application, the synchronization mechanism improves audio quality by synchronizing the sampling and outputting of each audio device on the bus. This improves audio quality by reducing the distortion that occurs as a result of varying sample times.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming-claims.

1. An apparatus comprising:
a) a bus, the bus transmitting a bus signal;
b) a first audio device coupled to the bus; and
c) a second audio device having a clock, the second audio device coupled to the bus and receiving the bus signal, the second audio device comparing the bus signal to the clock and adjusting the clock in response to the comparison.

2. The apparatus of claim 1 wherein the second audio device adjusts the clock by adding or subtracting clock cycles from a source clock related to the clock.

3. The apparatus of claim 1 wherein the comparison includes determining a difference amount from a desired clock phase and a current clock phase, and wherein the second audio device adjusts the clock by adding or subtracting a number of clock cycles from a source clock related to the clock, wherein the number of clock cycles is related to the difference amount.

4. The apparatus of claim 1 wherein the first audio device includes a first microphone input, and wherein the second audio device includes a second microphone input, and wherein the second audio device adjusts the clock to synchronize sampling of the first microphone input and the second microphone input.

5. The apparatus of claim 1 wherein the first audio device includes a first speaker output, and wherein the second audio device includes a second speaker output, and wherein the second audio device adjusts the clock to synchronize outputting of the first speaker output and the second speaker output.

6. The apparatus of claim 1 wherein bus comprises a time-multiplexed bus having a plurality of time slots, and wherein the second audio device compares the clock to a selected one of the plurality of time slots.

7. The apparatus of claim 1 wherein the first and second audio device comprise audio panels for crew communication on an aircraft.

8. An apparatus comprising:
a plurality of remote audio devices, each of the plurality of audio devices coupled to a bus and receiving a bus signal, each of the plurality of audio devices including:
i) a microphone input, the microphone input selectively sampling sound for distribution on the bus;
ii) a speaker for outputting sound distributed on the bus;
iii) a clock, the clock having a clock rate; and
iv) a synchronization mechanism, the synchronization mechanism receiving the bus signal and comparing to the bus signal to the clock, the synchronization mechanism adjusting the clock rate of the clock to synchronize the sampling of sound with sampling of sound on other of the plurality of audio devices.

9. The apparatus of claim 8 wherein each of the synchronization mechanism further synchronizes the outputting of sound with outputting of sound on the other of the plurality of audio devices.

10. The apparatus of claim 8 wherein each of the plurality of audio devices puts sampled sound on the bus in a corresponding slot determined by the clock.

11. The apparatus of claim 8 wherein the synchronization mechanism adjusts the clock rate by adding or subtracting clock cycles from a source clock related to the clock.

12. The apparatus of claim 8 wherein the comparing to the bus signal to the clock includes determining a difference amount from a desired clock phase with a current clock phase and wherein the synchronization mechanism adjusts the clock rate by adding or subtracting a number of clock cycles from a source clock related to the clock, wherein the number of clock cycles is related to the difference amount.

13. The apparatus of claim 8 wherein the bus comprises a time-multiplexed bus having a plurality of time slots, and wherein the synchronization mechanism compares the clock to a selected one of the plurality of time slots.

14. A method for synchronizing first and second audio devices connected by a bus, the method comprising the steps of:
a) comparing the time of arrival of a bus signal to the second audio device with a clock signal on the second audio device; and
b) adjusting the clock signal on the second audio device in response to the comparison.

15. The method of claim 14 wherein the step of adjusting the clock signal comprises adding or subtracting clock cycles from a source clock related to the clock.

16. The method of claim 14 wherein the step of comparing includes determining a difference amount from a desired clock phase and a current clock phase, and wherein the step of adjusting the clock signal comprises adding or subtracting a number of clock cycles from a source clock related to the clock, and wherein the number of clock cycles is related to the difference amount.

17. The method of claim 14 wherein the step of adjusting the clock signal comprises adjusting the clock signal to synchronize sampling of a first microphone input of the first audio device and a second microphone input of the second audio device.

18. The method of claim 14 wherein the step of adjusting the clock signal comprises adjusting the clock signal to synchronize outputting of a first speaker output of the first audio device and a second speaker output of the second audio device.

19. The method of claim 14 wherein the step of comparing the time arrival of a bus signal comprises comparing the time arrival of a selected time slot on the bus.

20. A method for synchronizing a plurality of remote audio devices, wherein each of the plurality of remote audio devices includes a microphone device, the microphone device selectively sampling sound for distribution on the bus, a speaker for broadcasting sound distributed on the bus, and a clock, the clock having a clock rate, the method comprising the steps of:
receiving the bus signal at each of the plurality of audio devices;
comparing the received bus signal to the clock at each of the plurality of audio devices; and
adjusting the clock rate of the clock at each of the plurality of audio devices to synchronize the sampling of sound with other of the plurality of devices.

21. The method of claim 20 wherein the step of adjusting the clock rate further synchronizes the outputting of sound with other of the plurality of devices.

22. The method of claim 20 further comprising the step of putting sampled sound on the bus in a corresponding slot determined by the clock.

23. The method of claim 20 wherein the step of adjusting the clock rate comprises adding or subtracting clock cycles from a source clock related to the clock.

24. The method of claim 20 wherein the comparing to the bus signal includes the step of determining a difference amount from a desired clock phase and with a current clock phase and wherein the step of adjusting the clock rate comprises adding or subtracting a number of clock cycles from a source clock related to the clock, wherein the number of clock cycles is related to the difference amount.

25. The method of claim 20 wherein the step of comparing comprises comparing the clock to a selected one of a plurality of time slots in the bus signal.
